(19) United States
(12) Patent Application Publication
(10) Pub. No.: US 2007/0249380 A1
(43) Pub. Date: Oct. 25, 2007

(54) Apparatus and method for broadcasting data

(75) Inventors: Kenneth A. Stewart, Grayslake, IL (US); Raja S. Bachu, Des Plaines, IL (US); Michael E. Buckley, Grayslake, IL (US); Robert T. Love, Barrington, IL (US); Eric R. Schorman, Bedford, TX (US); Jeffrey C. Smolinske, Schaumburg, IL (US)

Correspondence Address: MOTOROLA INC, 600 NORTH US HIGHWAY 45, ROOM AS437, LIBERTYVILLE, IL, 60048-5343, US

(73) Assignee: MOTOROLA, INC.

(21) Appl. No.: 11/406,762

(22) Filed: Apr. 19, 2006

(51) Int. Cl. H04B 7/00

(52) U.S. Cl. 455/502; 455/509; 455/524

(57) ABSTRACT

Disclose is a synchronized wireless communication network (100) operating in single frequency network mode comprising a first base station (502) broadcasting, on a first channel, broadcast data and a common sequence (508) that is generated from a first channel identifier, and wherein the first base station transmits data on a common control channel. A second base station (510), adjacent to the first base station and synchronized with the first base station, the second base station simultaneously broadcasting on the first channel the broadcast data and the common sequence, and wherein the second base station transmits data on a common control channel.

### CROSS-REFERENCE TO RELATED APPLICATIONS

This application is related to application entitled “APPARATUS AND METHOD FOR FEQUENCY HOPPING IN A BROADCST NETWORK,” Motorola case number CS29482RL, filed on even date herewith and commonly assigned to the assignee of the present application and which is hereby incorporated by reference.

### FIELD OF THE INVENTION

The present disclosure is directed to apparatus and methods for supporting data broadcasting in a single frequency network.

### BACKGROUND OF THE INVENTION

Presently, communication systems generally include a network operator serving user devices through a dedicated access network. For example, wireless communication systems in general comprise a Radio Access Network (RAN) and a core network (CN). The RAN includes base stations (BS) and associated radio network controllers providing wireless communication links with user device (UD), also referred to herein as user equipment (UE). The base stations may communicate with UE's individually or by broadcasting common data to multiple UE's also known as multicasting. The core network receives messages or content to be broadcast to a plurality of UE's. The data may be unicast or multicast to the UE's from a base station.

Some RANs are synchronized while others are not. For the present purpose, a ‘synchronous’ network comprises base stations which are synchronous in time and frequency. That is, by exploiting e.g. Global Positioning System (GPS) receivers, or some other network-based locating means, the frame, timeslot or symbol boundaries of the transmissions from each base station (or subset of base stations) can be made substantially simultaneous, while the carrier frequencies at each BS can be synthesised with very small relative error.

With such a synchronized network, the operator may designate at least one physical channel to be simultaneously transmitted—i.e. ‘simulcast’—from at least two BS's to form a single frequency network (SFN) such that the UE's may receive the same broadcast data on the single frequency throughout the network, or subset of participating BS's. That is, the same data is simulcast synchronously by all the participating base stations in the SFN. Thus, each base station transmits the same data on the same frequency in a fully synchronous fashion.

Current network operation may be frequently conditioned on the application of frequency re-use methods, where controlled levels of interference are permitted. Frequency hopping methods are frequently combined with frequency re-use schemes, to permit higher levels of frequency diversity and interference mitigation. Known sequences, or training sequences, are typically transmitted by base and mobile stations in such networks.

Thus, there is a need for efficient methods of mapping SFN's onto networks supporting frequency hopping and training sequences.

### BRIEF DESCRIPTION OF THE DRAWINGS

Exemplary embodiments of the present invention will be described with reference to the following figures, wherein like numerals in different figures designate like elements and which embodiments are provided to illustrate various principles and advantages of the invention defined by the claims, and wherein:

FIG. 1 is a diagram illustrating an exemplary wireless communication system;

FIG. 2 is a diagram illustrating an exemplary wireless communication system;

FIG. 3 is an exemplary network diagram;

FIG. 4 is a diagram illustrating an exemplary data burst;

FIG. 5 illustrates an exemplary network transmitting broadcast—data on the same channel;

FIG. 6 illustrates exemplary broadcast data frames; and

FIG. 7 illustrates exemplary broadcast and unicast data frames.

### DETAILED DESCRIPTION OF THE DRAWINGS

Disclosed is a synchronized wireless communication network and method for operating thereof, comprising a first base station broadcasting, on a common channel, broadcast data and a common sequence that is generated from a common channel identifier, and wherein the first base station also transmits data on a first common control channel. A second base station, proximal to the first base station and synchronized with the first base station, the second base station simultaneously broadcasting on the common channel the broadcast data and the common sequence, and wherein the second base station transmits data on a second common control channel.

In general, a wireless communication system comprises a plurality of base transceiver stations providing wireless communication service, including voice and/or data service, to wireless terminals over corresponding regions or cellular areas. The wireless terminals may be referred to as wireless communications devices, mobile stations, mobiles, user equipment, handheld, mobile unit or the like. The base transceiver stations, also referred to by other names such as base station, “Node B” or the like depending on the system type, are communicably coupled to a controller and to other entities and well known by those having ordinary skill in the art. The base station is part of a radio access network portion of the one wireless communication system. Exemplary communication systems include, but are not limited to, Global System for Mobile communications (GSM) networks, Code Division Multiple Access System (CDMA) networks, Universal Mobile Telecommunications System (UMTS) networks, Evolved UMTS (E-UMTS or E-UTRA) networks, and other OFDM based networks.

Before describing in detail embodiments that are in accordance with the present invention, it should be observed that the present invention resides primarily in combinations of method steps and apparatus components related to the communication device, communication node, and method for broadcasting data from a network. Accordingly, the apparatus components and method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non- exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A core network is generally coupled to an access network which in general is a wireless communication network). Wireless, may operate in accordance with certain protocols such as the UMTS, GSM, and CDMA type system, and may be circuit switched and/or packet switched. The communication systems of interest are those that facilitate voice or data or messaging services over one or more networks. Furthermore, the systems may be wide area networks, local area networks, or combinations thereof, and the user devices of interest can support short-range communications, long-range communications, or both long and short-range communications. Examples of short range communications include cordless communications systems, pico-networks, wireless LAN systems such as those supporting IEEE 802.11 standard, Bluetooth connections, and the like. Such systems preferably utilize CDMA, frequency hopping, or TDMA access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System), or integrated digital enhanced network (iDEN™) protocol. Such systems may support trunk or dispatch functions, direct individual or group calling, and support circuit switched, Internet or other connections.

User devices in such systems may include cellular telephones, cordless telephones, internet or internet protocol phones, modems, routers, access points, computers, personal digital assistants, palm top devices, and variations and evolutions thereof.

The instant disclosure includes exemplary devices, systems, and methods, which disclose various embodiments. However, the structure and function disclosed is not intended to limit the invention, but rather to enhance an understanding and appreciation for the inventive principles and advantages. The invention is limited solely by the claims.

Terms used in the specification and claims may be associated by those skilled in the art with terminology appearing in a particular standard, such as CDMA, GSM or 802.xx standards, or such terminology may not appear in a particular standard. Association with a standard is not intended to limit the invention to a particular standard, and variances with the language in a standard does not preclude the invention from applying to such standard. Rather, the terms used are provided solely for the purpose of explaining the illustrated examples without unduly burdening the specification with multiple explanations to accommodate language variations with all possible standards, systems, and networks. It is further understood that the use of relational terms, if any, such as first and second, top and bottom, and the like are used solely to distinguish elements or actions without necessarily requiring or implying any actual such relationship or order between such entities or actions.

Those skilled in the art will recognize that the inventive functionality and many of the inventive principles may be implemented using software programs, hardware circuits such as integrated circuits (ICs), programmable logic devices, or a combination thereof. It is expected that one of ordinary skill, notwithstanding the amount of effort required and the many design choices driven by available time, current technology, and economic considerations, when guided by the concepts and principles disclosed herein will be readily capable of generating and selecting such software programs and/or ICs with minimal experimentation. In the interest of brevity and minimization of any risk of obscuring the principles and concepts according to the present invention, further discussion of such software and ICs, if any, will be limited to the essentials with respect to the principles and concepts used by the preferred embodiments.

FIG. 1 is an exemplary diagram illustrating a cell topology for a wireless communication system 100. In this embodiment, the entire system 100 is operating as a single frequency communication network (SFN). The communication network 100 is comprised of a plurality of base stations 102 positioned relative to one another such that they form approximate hexagonally shaped cells (in an actual deployment, the coverage area of each cell may substantially deviate from this structure). The hexagonal shape and layout of cell sites, (i.e. base stations) may vary from network to network and is known to those of ordinary skill in the art. Each base station within the network, or a subset of the base stations, may broadcast data on a single channel or frequency, thereby creating what is known as a single frequency network. This single channel is a common data channel used by all of the base stations comprising the SFN. It is to be understood that the “single frequency” in one embodiment may be a single radio frequency. In another embodiment, the “single frequency” may be a single logical channel. In this embodiment, the single channel may be made up of a plurality of physical frequencies, the frequencies changing over time at predetermined intervals according to a specified pattern.

Transmissions from individual cells (i.e. base stations) are simulcast in single-frequency network fashion where the participating cells support sufficiently precise time- and frequency-synchronization to construct a single multipath channel from the network to the mobile station consisting of the sum of the individual per-cell radio channel impulse responses. Provided the resulting composite multipath channel impulse response length is less than a pre-determined duration (e.g. established by the mobile station receiver's ability to equalize the resulting impulse response), broadcast receiver performance is limited not by interference, but rather by a) base station and mobile station implementation impairments (such as transmitter non-linearities, receiver thermal and phase noise, quadrature error etc.), and b) Doppler-induced (i.e. motion-induced) variation of the channel to each BS within a symbol or frame interval, and c) any residual excess time-delay components beyond the pre-determined impulse response duration. Provided such effects are sufficiently controlled, the fundamental interference-limited mode of operation of conventional cellular systems employing frequency re-use methods can be avoided, and, in the effective absence of interference, much higher signal-noise ratios (SNR's) may be achieved in the system given the same cell locations and radiated power levels. This in turn can enable high broadcast network spectral efficiency.

In FIG. 1, the number “1” in the diagram placed within each cell, and within each sector of a plurality of the cells, represents the channel that the respective base station uses for communication with a mobile or a remote device. The “1” indicates in this embodiment, that at a particular moment in time (e.g. symbol, frame, or timeslot duration), all base stations are transmitting on channel 1. In other words, in the exemplary embodiment as shown in FIG. 1 each base station broadcasts the same data on the same channel or frequency.

All of the base stations in the SFN are synchronized and therefore may transmit broadcast-data at the same time and on the same channel or frequency. A channel may be a logical channel or a physical channel. The channel may be made up of a single frequency carrier or multiple frequency carriers as discussed above, however with the constraint that at any one point in time, all base stations within the network are broadcasting the same data on the same, single, physical channel or carrier frequency.

Each base station also transmits data on a common control channel. The common control channel may also be a physical frequency, or a logical channel mapped to one or more frequencies. In this exemplary embodiment, each base station transmits data on a broadcast common control channel, (BCCH). Each base station transmits on a different BCCH in one embodiment. In another embodiment, all the base stations broadcast on the same BCCH within the limits of a frequency re-use pattern.

It is to be understood that each base station may also have other channels operating concurrently with the single frequency network portion of the network. For example, each base station may support a plurality of 2-way radio calls with mobile stations for typical cellular radiotelephone operation. At the same time, the base stations are broadcasting data to the same or to other mobile stations within the coverage area of the base station. Each base station may also support more than one SFN or may use more than channel per SFN. This may include the transmission of the broadcast data on more than one channel.

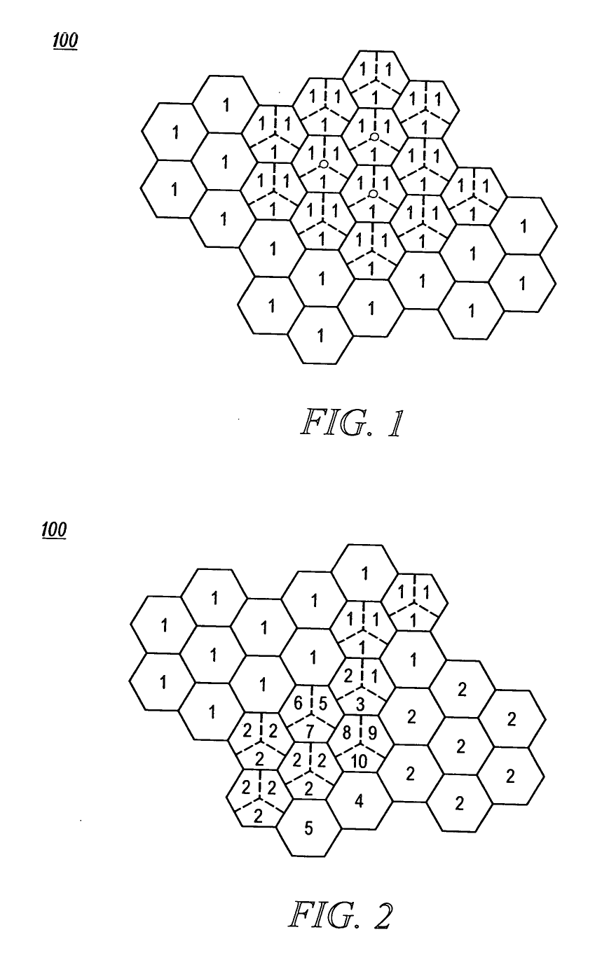

FIG. 2 is a diagram illustrating one exemplary wireless communication system wherein a portion of the network operates as a SFN utilizing a first SFN frequency; another portion of the network utilizes a second SFN frequency, and a third portion utilizes a typical reuse pattern of frequencies.

In the cells designated to operate as a SFN, as in FIG. 1 or FIG. 2, the data to be broadcast is divided into portions, also known as packets, frames or data bursts. The network of the exemplary embodiment of FIG. 1 is based on time division multiplexing and bursts are transmitted in the time frames or time intervals in accordance with the size of the time interval. The data is divided into bursts prior to transmission by the base station and then recombined at the receiving end (e.g. a mobile station). Included in each burst is the data of the broadcast, i.e. the broadcast data and a common sequence that is generated from and associated with the first channel identifier. The common sequence is common between the between the base stations and specific to the SFN channel.

In one embodiment, a first base station specific sequence (BSSS) is transmitted by the first base station and is generated based on a first base station identifier. In one embodiment the first base station identifier is referred to as a base station color code (BCC). The first base station identifier, identifies the base station to the mobile station, or at least identifies the base station identity within the limits of the BCC re-use pattern.

In one embodiment a second BSSS is transmitted by the second base station and is generated based on a second base station identifier. the BCC in this embodiment. The second base station identifier, identifies the second base station to the mobile station. Data having the first BSSS embedded therein is transmitted from the first base station, while data having the second BSSS is being transmitted from the second base station. In addition, a data burst having the common sequence is associated with the broadcast channel and is transmitted from both the first and second base stations in substantially synchronous fashion.

In one embodiment, the common sequence is broadcast on the same frequency as the first BSSS during non overlapping time intervals. In an alternative embodiment, the common sequence and the first BSSS may also be broadcast in overlapping time interval however on different channels or frequencies.

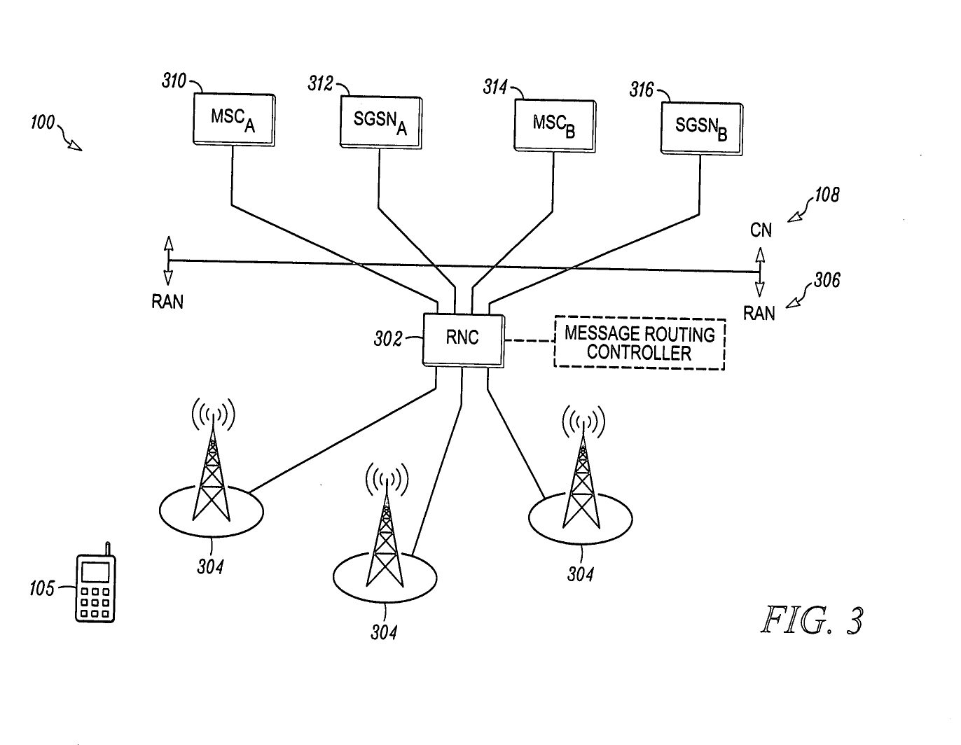

In one embodiment, illustrated in FIG. 3, the communication system 100, further comprises at least one radio network controller (RNC) 302, base stations 304, mobile switching center (MSC) A 310 and maybe MSC B 314, Serving GPRS Support Node (SGSN) A 312 and maybe SGSN B 316, and user devices (UD) or mobile stations (MS) 305. The RNC 302 and the base stations 304 are a radio access network (RAN) 306 in system 100. The core networks 108 include MSC A 310, MSC B 314, SGSN A and SGSN B 316 and are coupled to the RAN and to other entities, such as the public switch telephone network and the Internet. It is to be understood that this is an exemplary network and that other network components may be used to form the network. For example, not all networks may include a Serving GPRS Support Node. Further this embodiment includes two core networks for exemplary purposes. In alternate embodiment, the RNC 302 may be coupled to one or more core networks. All of the base stations 304 coupled to the RNC 302 participate in the SFN in this embodiment.

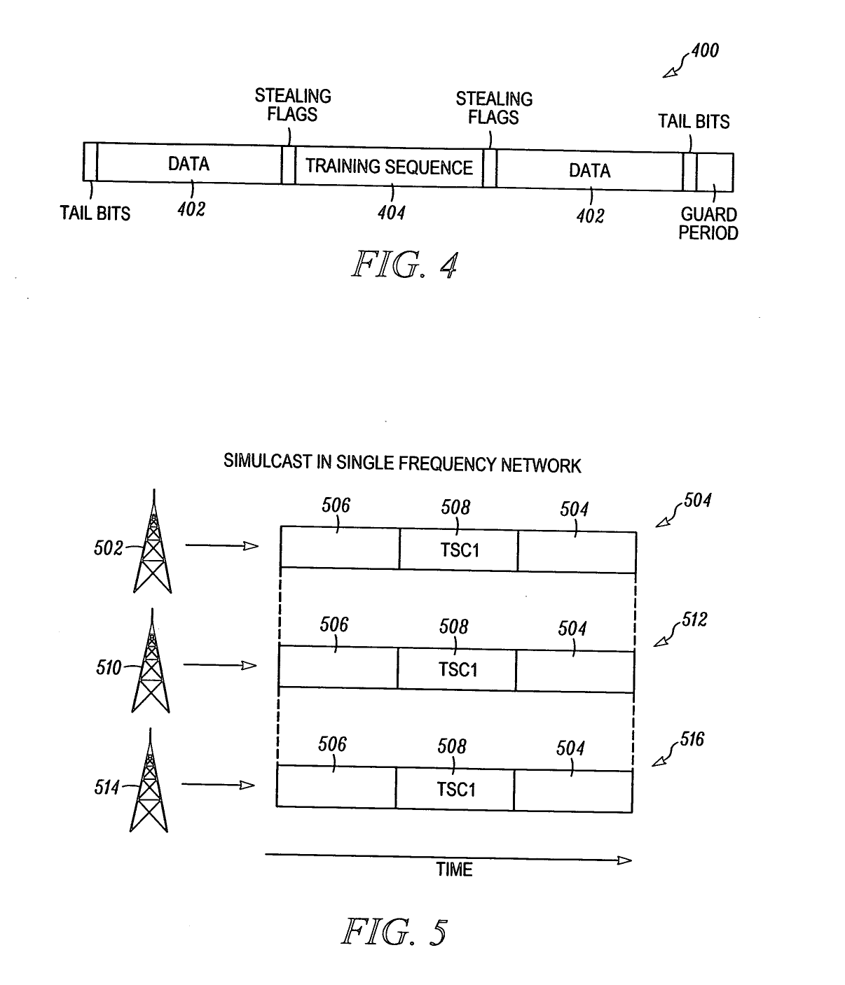

FIG. 4 illustrates an exemplary data burst 400 of the communication system. The data burst 400 includes a broadcast data portion 402 and a common sequence portion which in this exemplary embodiment is a training sequence code 404. The data burst 400 may also contain other information. For example, the data burst may contain tail bits, checksums, forward error correction information, flags a guard period and the like. The common sequence 404 is associated with the first channel and may be referred to as a first channel common sequence. In one embodiment, the common sequence is generated from the common data channel identifier and in this embodiment is generated from the broadcast channel identifier identifying the broadcast channel.

FIG. 5 illustrates an exemplary network transmitting broadcast—data simultaneously on the same channel, the broadcast channel in this exemplary embodiment. Each data burst from each base station includes the same common sequence which is a first training sequence code (TSC) in this embodiment. A first base station 502 is broadcasting a first data burst 504. The first data burst 504 includes the data 506 and the first TSC 508. A second base station 510 is broadcasting a second data burst 512. The second data burst includes the data 506 and the first TSC 508. A third base station 514 is broadcasting a third data burst 516. The third data burst 516 includes the data 506 and the first TSC 508. The first data burst 504, the second data burst, 512 and the third data burst 516 are broadcast at the same time from the three exemplary base stations, as the base stations are synchronized. Additionally, the first data burst 504, the second data burst, 512 and the third data burst 516 are broadcast on the same channel.

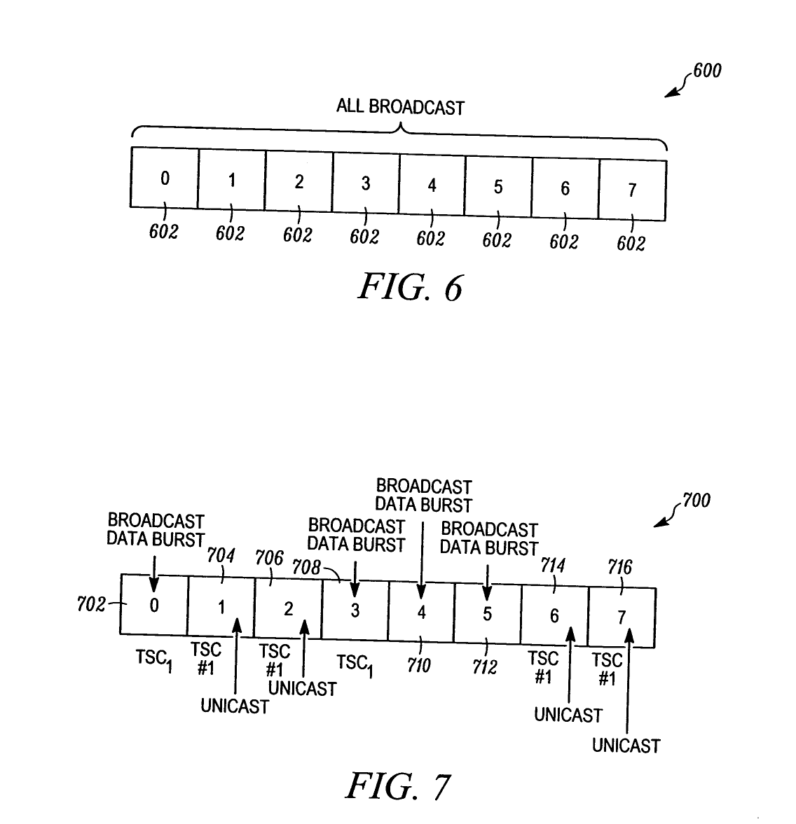

FIG. 6 illustrates a data frame 600 having eight bursts 602 divided into equal time intervals. In this embodiment, all bursts are broadcast or multicast bursts. In this embodiment, the TSC is associated with the broadcast channel identifier. For example, each data burst that is broadcasting data on a first broadcast channel has the same TSC.

FIG. 7 illustrates a composite data frame 700. In this embodiment, each data burst within the frame may be a unicast transmission, such as burst “1” 704, burst “2” 706, burst “6” 714 and burst “7” 716. The remaining bursts within the frame are broadcast data bursts. The broadcast data burst may all have the same TSC—denoted TSC#1 in the figure—as discussed in relation to FIG. 6 or may be different TSC's derived from different SFN's. The unicast data bursts however will have unique TSC's—denoted TSC1—generated from the base station identifier.

Therefore, in one embodiment, the base station is transmitting during a first time interval 704 a first predetermined sequence generated as a function of a base station identifier. The base station is also transmitting during a second time interval 708, a second predetermined sequence generated as a function of a broadcast channel identifier. The second predetermined sequence is a common sequence, that is generated as a function of the broadcast channel identifier. Any of the sequences in this may be predetermined randomly or pseudo-randomly. In another embodiment, the sequences are generated randomly.

In one embodiment, the mobile station 305 will enter and exit sleep mode, in order to conserve energy and reduce current drain. In sleep mode, the mobile station 305 runs a clock or timer to determine when to wake and send or receive message from the network. In one embodiment, the mobile station 305 will wake only to receive transmissions that contain a predetermined TSC. During sleep mode the mobile station 305 monitors the TSC and wakes to receive data only when the predetermined broadcast TSC is received. The mobile station 305 receives the data and then trains the mobile station 305 equalizer with the received TSC. In this embodiment, the TSC is generated from the broadcast channel identifier.

In another embodiment, the mobile station 305 may determine that the frame is a unicast data burst when the TSC is a unicast TSC and a broadcast data burst when the TSC is a broadcast TSC. The mobile station 305 may then train the mobile station equalizer with the received TSC.

Thus it can be seen that an improved methods and apparatus are disclosed. While this invention has been described with specific embodiments thereof, it is evident that many alternatives, modifications, and variations will be apparent to those skilled in the art. For example, various components of the embodiments may be interchanged, added, or substituted in the other embodiments. Various changes may be made without departing from the spirit and scope of the invention.

What is claimed:

1. A synchronized wireless communication network operating in single frequency network mode comprising:
a first base station broadcasting, on a first channel, broadcast data and a common sequence that is generated from a first channel identifier, and wherein the first base station transmits data on a first common control channel; and
a second base station, proximal to the first base station and synchronized with the first base station, the second base station simultaneously broadcasting on the first channel the broadcast data and the common sequence, and wherein the second base station transmits data on a second common control channel.

2. The synchronized network of claim 1, wherein the common control channel is a broadcast control channel (BCCH).

3. The synchronized network of claim 1, wherein a first base station specific sequence is transmitted by the first base station and is generated based on a first base station identifier (BCC).

4. The synchronized network of claim 3, wherein a second base station specific sequence is transmitted by the second base station and is generated based on a second base station identifier (BCC).

5. The synchronized network of claim 1, the common sequence is broadcast on the same frequency as the first base station specific sequence during non overlapping time intervals.

6. The synchronized network of claim 1, wherein the first channel is a broadcast channel having a broadcast channel identifier.

7. The synchronized network of claim 6, wherein the broadcast channel comprises a plurality of hopping frequencies.

8. The synchronized network of claim 1, wherein the broadcast data further comprising a data burst in which the common sequence is generated according to the broadcast channel identifier and is substantially simultaneously transmitted by the first base station on the first channel and by the second base station on the first channel.

9 A method for broadcasting data comprising:
transmitting during a first time interval a first predetermined sequence generated as a function of a base station identifier; and
transmitting during a second time interval, a second predetermined sequence generated as a function of a broadcast channel identifier.

10. The method of claim 9 wherein the at least first and a least second predetermined sequences are transmitted on a time-division basis within data bursts on the same channel.

11. The method of claim 10 where the predetermined sequences generated from the broadcast channel identifier vary as a function of time.

12. A method in a mobile station comprising
waking from sleep mode at a time when a burst is received containing the broadcast training sequence code; and
training the mobile station equalizer with the training sequence code received.

13. A method in a mobile station comprising:
determining whether a received frame is a broadcast frame or a unicast frame based on a training sequence code received in a burst; and
training the mobile station equalizer with the training sequence code received.

14. A method for receiving broadcast data from a synchronized network having a plurality of base stations comprising:
receiving a first data burst from a first base station, the first data burst including a training sequence code that is generated from a broadcast channel identifier;
receiving a second data burst from a second base station, the second data burst including the training sequence code generated from the broadcast channel identifier.

15. The method of claim 14, further comprising receiving on a same broadcast channel, identified by the broadcast channel identifier, the first data burst from the first base station and the second data burst from the second base station.

16. A method for broadcasting data by a single frequency network, wherein each base station participating in the SFN uses a single broadcast channel identifier, comprising:
transmitting a base station associated unicast training sequence code in a first time burst, and
transmitting a broadcast channel identifier associated training sequence code in a second time burst.

17. The method of claim 16 wherein the first time burst and the second time burst are non-overlapping.

18. The method of claim 17 where the predetermined sequences are equalizer training sequences.
